(19) United States
(12) Patent Application Publication
(10) Pub. No.: US 2026/0260306 A1
(43) Pub. Date: Sep. 3, 2026

(54) METHODS FOR AUTO CONTRACT VULNERABILITY ANALYSIS

(71) Applicant: Health Strategy, LLC, Peoria, IL (US)

(72) Inventors: Jack Carson, Peoria, IL (US); Brandon Clark, Peoria, IL (US); Justin Dell, Peoria, IL (US); Nick James, Peoria, IL (US)

(21) Appl. No.: 19/550,929

(22) Filed: Feb. 26, 2026

Related U.S. Application Data
(60) Provisional application No. 63/765,285, filed on Feb. 28, 2025.

(51) Int. Cl. G06Q 50/18; G06F 40/30

(52) U.S. Cl. CPC G06Q 50/18; G06F 40/30

(57) ABSTRACT

A method for performing contract vulnerability analysis using a large language model (LLM) is disclosed. The method includes receiving an uploaded document, which is processed to extract and preserve its content. The extracted text is translated into high-dimensional embeddings using an open-source embedding model, and both the embeddings and text are stored in a vector database. A predefined template, containing analysis characteristics, is selected for further analysis of the document's content. The vector database is queried to retrieve language matching the analysis characteristics, with the LLM generating insights, including a vulnerability score and recommendations. A report is generated, presenting these insights, the vulnerability score, and the recommendations for mitigating identified risks.

### CROSS-REFERENCE TO RELATED APPLICATIONS

This application claims the benefit of U.S. Application No. 63/765,285, filed February 28, 2025, the entire contents of which are incorporated herein by reference in their entirety.

### FIELD OF THE TECHNOLOGY

The present technology relates to a system and method for the ingestion, analysis, and identification of key characteristics within contractual agreements between parties. The identified characteristics are analyzed to evaluate the agreements, providing insights, and facilitating informed decision-making for organizations.

### BACKGROUND

In enterprise environments, particularly within the pharmaceutical and healthcare industries, contracts are routinely analyzed to ensure compliance with industry standards and corporate requirements. These contracts, often lengthy and complex, undergo in-depth review by internal resources to confirm that best practices in contractual management are met. The analysis involves a meticulous examination of the agreements to ensure they align with regulatory and legal frameworks, managing risks, and maintaining contractual integrity. This process is a standard practice in the industry, ensuring that agreements are executed in accordance with established standards and corporate policies.

Ensuring that contractual agreements are executed per established standards and corporate policies is crucial for maintaining an enterprise's legal and operational integrity. Compliance with these standards minimizes the risk of legal disputes, regulatory penalties, and financial losses, safeguarding the organization's reputation and financial stability. Adhering to corporate policies also ensures that all parties involved in the contract operate under clearly defined and mutually agreed-upon terms, enhancing trust and accountability. Moreover, alignment with industry standards promotes consistency and reliability across contractual engagements, enabling the enterprise to effectively manage risks and obligations while maintaining competitive advantage in the market.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict exemplary embodiments of the disclosure and are not therefore to be considered to be limiting of its scope, the principles herein are described and explained with additional specificity and detail through the use of the accompanying drawings in which:

FIG. 1 illustrates an example user interface of a mobile application to initiate the automatic contract vulnerability analysis according to some aspects of the disclosure.

FIG. 2 illustrates an example template for selecting one or more categories to perform the contract vulnerability analysis according to some aspects of the disclosure.

FIG. 3 illustrates an example executed summary of a contract vulnerability analysis report according to some aspects of the disclosure.

FIG. 4 illustrates an example report generated by the computing system according to some aspects of the disclosure.

FIG. 5 illustrates a financial terms report of the contract vulnerability analysis according to some aspects of the disclosure.

FIG. 6 illustrates an example output for the contract vulnerability analysis of one or more definitions selected from the analysis categories according to some aspects of the disclosure.

FIG. 7 illustrates an example of an exclusion report according to some aspects of the disclosure.

FIG. 8 illustrates an example response to a natural language question using context from the contract language according to some aspects of the disclosure.

FIG. 9 illustrates an example of a chat output in response to natural language questions within a chat session according to some aspects of the disclosure.

FIG. 10 is a block diagram illustrating an exemplary machine learning platform for implementing various aspects of this disclosure in accordance with some embodiments of the present technology.

FIG. 11 illustrates an example lifecycle of an ML model in accordance with some embodiments of the present technology.

FIG. 12 illustrates an example of a deep learning neural network according to some embodiments of the present technology.

FIG. 13 illustrates a process 1300 for performing contract vulnerability analysis by a large language model (LLM) in accordance with one embodiment.

FIG. 14 illustrates an example of a computing system according to some aspects of the present disclosure.

### DETAILED DESCRIPTION

Various examples of the disclosure are discussed in detail below. While specific implementations are discussed, it should be understood that this is done for illustration purposes. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an example in the present disclosure can be references to the same example or any example; and, such references mean at least one of the examples.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative, and is not intended to further limit the scope and meaning of the disclosure or of any example term. Likewise, the disclosure is not limited to various embodiments given in this specification.

Additional features and advantages of the disclosure will be set forth in the description that follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

The proposed solution offers automatic contract vulnerability analysis by streamlining the ingestion, assessment, and extraction of actionable insights for pharmaceutical and healthcare contracts, utilizing an organization's best practices. It employs a comprehensive pipeline of document processing, vector embeddings, natural language processing, HNSW search, and machine learning to efficiently analyze complex, industry-specific agreements. The process starts with the secure storage of uploaded documents in Amazon Web Service Simple Storage Service (AWS S3), followed by the use of Amazon Web Service (AWS) Textract to extract and preserve the document's structural integrity. Users can define specific analysis criteria, and the system queries a vector database using company best practices to retrieve relevant contractual language. The technology identifies semantically similar language across multiple amendments and prioritizes terms for application across the entire contract, with final analyses processed by an LLM on AWS and compiled into a detailed, editable report.

In one aspect, a method for performing contract vulnerability analysis by a large language model (LLM), the method includes receiving, by a computing system, an input including an upload of a document, the uploaded document includes content for analysis by the LLM, extracting, by the computing system, the content from the uploaded document, where the extraction is configured to preserve an integrity of the content into one or more sets of extracted text, translating the one or more sets of extracted text into high-dimensional embeddings using an open-source embedding model, where the high-dimensional embeddings and the extracted text are stored in a vector database, receiving, by the computing system, an input includes a selection of a template from one or more predefined templates, each template includes a set of analysis characteristics to utilize in the analysis of the content of the uploaded document, and one or more inquiries for the LLM to conduct the analysis using context from the content, in response to the selection, querying the vector database based on the set of analysis characteristics in the selected template to retrieve language from the document, where the query identifies semantically similar language to the set of analysis characteristics, inputting the retrieved language including a context of the retrieved language and one or more instructions for performing the analysis into the LLM, where the LLM is configured to generate one or more insights related to the content related to the set of analysis characteristics, the one or more insights including a vulnerability score and one or more recommendations to remediate the vulnerability score, and generating, at the computing system, a report including the one or more generated insights received from the LLM, where the report includes the vulnerability score of the content and the one or more recommendations.

In some aspects, the method may also include where the uploaded document is stored a scalable Amazon Simple Storage Service (AWS S3).

In some aspects, the method may also include where the extracting includes the extraction of a plurality of text layouts, paragraphs, lists, continuous statements, and tables from the uploaded document.

In some aspects, the method may also include where the vector database stores the high-dimensional embeddings and the extracted text in one or more collections allowing for processing of a semantic search and retrieval of relevant information upon receiving a request.

In some aspects, the method may also include where the set of analysis characteristics includes a plurality of categories including one or more definitions, terms, and exclusion types for use in the analysis of the content of the uploaded document for comparison with a predefined data set of organizational best practices.

In some aspects, the method may also include further includes identifying, by the LLM, the document includes one or more amendments to content within the document, where the one or more amendments comprise an amendment to one or more terms in the document, associating the amendment to the one or more terms with predefined terms in the set of analysis characteristics, where the set of analysis characteristics includes a priority level for each of the predefined terms, and providing a relevance score to the amendment of the one or more terms based on the priority level in the set of analysis characteristics.

In some aspects, the method may also include further includes receiving, by the computing system, an input via a chatbot associated with the computing system, the input includes a natural language request including one or more inquiries for further analysis of the content of the uploaded document to identify compliance with the set of analysis characteristics, inputting the natural language request into the LLM for processing, and outputting, by the computing system, a response generated by the LLM in response to the natural language request, where the response includes context supporting the response to the inquiry.

In one aspect, a system for performing contract vulnerability analysis by a large language model (LLM), the system includes a memory and one or more processors that executes instructions stored in the memory, where the processor executes the instructions to receive an input including an upload of a document, the uploaded document includes content for analysis by the LLM, extract the content from the uploaded document, where the extraction is configured to preserve an integrity of the content into one or more sets of extracted text, translate the one or more sets of extracted text into high-dimensional embeddings using an open-source embedding model, where the high-dimensional embeddings and the extracted text are stored in a vector database, receive an input includes a selection of a template from one or more predefined templates, each template includes a set of analysis characteristics to utilize in the analysis of the content of the uploaded document, and one or more inquiries for the LLM to conduct the analysis using context from the content, in response to the selection, query the vector database based on the set of analysis characteristics in the selected template to retrieve language from the document, where the query identifies semantically similar language to the set of analysis characteristics, input the retrieved language including a context of the retrieved language and one or more instructions for performing the analysis into the LLM, where the LLM is configured to generate one or more insights related to the content related to the set of analysis characteristics, the one or more insights including a vulnerability score and one or more recommendations to remediate the vulnerability score, and generate a report including the one or more generated insights received from the LLM, where the report includes the vulnerability score of the content and the one or more recommendations.

In one aspect, a non-transitory computer-readable storage medium, having embodied thereon a program executable by a processor to perform a method for data pattern analysis, the method includes receiving, by a computing system, an input including an upload of a document, the uploaded document includes content for analysis by an LLM, extracting, by the computing system, the content from the uploaded document, where the extraction is configured to preserve an integrity of the content into one or more sets of extracted text, translating the one or more sets of extracted text into high-dimensional embeddings using an open-source embedding model, where the high-dimensional embeddings and the extracted text are stored in a vector database, receiving, by the computing system, an input includes a selection of a template from one or more predefined templates, each template includes a set of analysis characteristics to utilize in the analysis of the content of the uploaded document, and one or more inquiries for the LLM to conduct the analysis using context from the content, in response to the selection, querying the vector database based on the set of analysis characteristics in the selected template to retrieve language from the document, where the query identifies semantically similar language to the set of analysis characteristics, inputting the retrieved language including a context of the retrieved language and one or more instructions for performing the analysis into the LLM, where the LLM is configured to generate one or more insights related to the content related to the set of analysis characteristics, the one or more insights including a vulnerability score and one or more recommendations to remediate the vulnerability score, and generating, at the computing system, a report including the one or more generated insights received from the LLM, where the report includes the vulnerability score of the content and the one or more recommendations.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

In many commercial settings, particularly within the pharmaceutical and healthcare industries, the analysis of contracts is often performed manually, a process that is both time-consuming and prone to error. These contracts are typically lengthy and complex, requiring a detailed review to ensure they meet industry standards and corporate compliance requirements. To uphold best practices, it is essential that this analysis be conducted with both speed and precision. However, the manual approach often falls short, as it lacks the efficiency needed to handle the volume and intricacy of such agreements. This underscores the need for an automated system that can rapidly and accurately analyze contractual agreements, ensuring that all relevant standards and compliance protocols are consistently met.

When contracts are analyzed, there are inherent risks for vulnerabilities that, if not addressed, can lead to significant contractual risks for an entity or organization. These risks arise from potential gaps or oversights in the agreement, which could expose the organization to legal disputes, financial losses, or non-compliance with regulatory requirements. Therefore, ensuring that all contractual agreements meet compliance standards, organizational practices, and industry standards is imperative. By doing so, the organization can mitigate these risks and safeguard its interests throughout the execution of the agreement.

The proposed solution addresses these challenges by providing automatic contract vulnerability analysis for contractual agreements. This technology streamlines the process of ingesting, assessing, and providing actionable insights for pharmaceutical and healthcare contracts, by leveraging a plurality of best practices of an organization. The proposed technology provides for an efficient pipeline of document processing, vector embeddings, natural language processing, HNSW search, and machine learning processes to analyze complex, industry-specific contractual agreements quickly and accurately.

The process initiates with the ingestion of a document, which can be provided in various formats, including txt, docx, or pdf. Upon ingestion, the document is securely stored in AWS S3, leveraging its scalable and reliable storage capabilities. AWS Textract is subsequently employed to extract text layouts and tables from the document, ensuring the preservation of the structural integrity of paragraphs, lists, and continuous statements. Users are then empowered to specify particular definitions, terms, and exclusion criteria for targeted analysis, as well as to submit general inquiries for a large language model (LLM) to address using contextual data from the contract during subsequent stages. The application interrogates the vector database using embeddings derived from the company’s best practices for each specified item within the template, efficiently retrieving the corresponding contractual language. This search process also identifies semantically equivalent language, particularly in scenarios where contracts include multiple amendments, and it recognizes the chronological sequencing of terms in more extensive agreements. In such instances, it prioritizes redefined terms for application across the entire contract. The retrieved language, accompanied by relevant contextual information and instructions, is then processed by an LLM hosted on AWS. The resultant analyses are compiled into a detailed report, which can be viewed, printed, edited, or deleted.

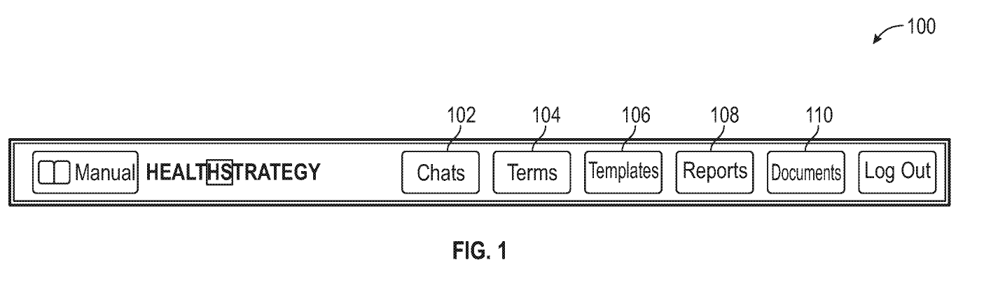

FIG. 1 illustrates an example user interface 100 of a mobile application to initiate the automatic contract vulnerability analysis according to some aspects of the disclosure.

User interface 100 of the mobile or software application includes multiple user selection options, including tables 102, reports 104, templates 106, and collections 108, each providing distinct functionalities within the analysis workflow. To initiate the analysis, the user can upload a document, which can be in various formats such as txt, docx, or pdf. In some examples, the document can be a contractual agreement, technical documentation, or another document that is in need of contract vulnerability analysis. Once uploaded, the document can be stored in an AWS S3 scalable storage infrastructure. An extraction tool, such as AWS Textract, can be employed to extract and preserve the integrity of text layouts and tables from the document, maintaining the structure of paragraphs, lists, and continuous statements.

The extracted content can be segmented into discrete chunks or sections and processed into high-dimensional embeddings using an open-source embedding model. These embeddings and the corresponding text are indexed and stored in a vector database, organized as collections accessible via the collections 108 selection option within the interface. Upon completion of the processing of the document, users can engage with the user interface 100 to retrieve and review specific analytical outputs. Selecting tables 102 can enable the retrieval of the extracted tables from the document, allowing for detailed examination of structured data.

By selecting reports 104, users can access comprehensive reports generated in relation to the uploaded document. These reports may include large language model (LLM)-driven analyses that assess compliance with regulatory standards, organizational policies, or predefined best practices. The templates 106 option can provide access to a repository containing a database of industry-specific templates, encompassing key analysis characteristics such as definitions, financial terms, preferred language, pharmacy claim types, and best practices. These templates are utilized by the LLM to guide the LLM’s analytical process. Additionally, user interface 100 supports the updating of templates within the repository, allowing users to refine and customize the analysis parameters as needed, further enhancing the accuracy and relevance of the contract vulnerability analysis.

A selection can further be received to start new chat 110. By selecting start new chat 110, a user can interact with a chatbot to ask questions with regards to a document or contractual agreement uploaded. An LLM in communication with the LLM can analyze the contract to identify responses and corresponding sections of the document that are relevant to the user’s question.

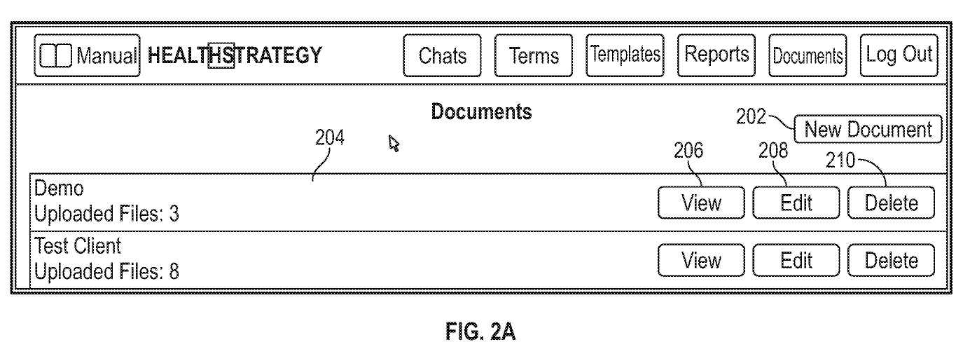

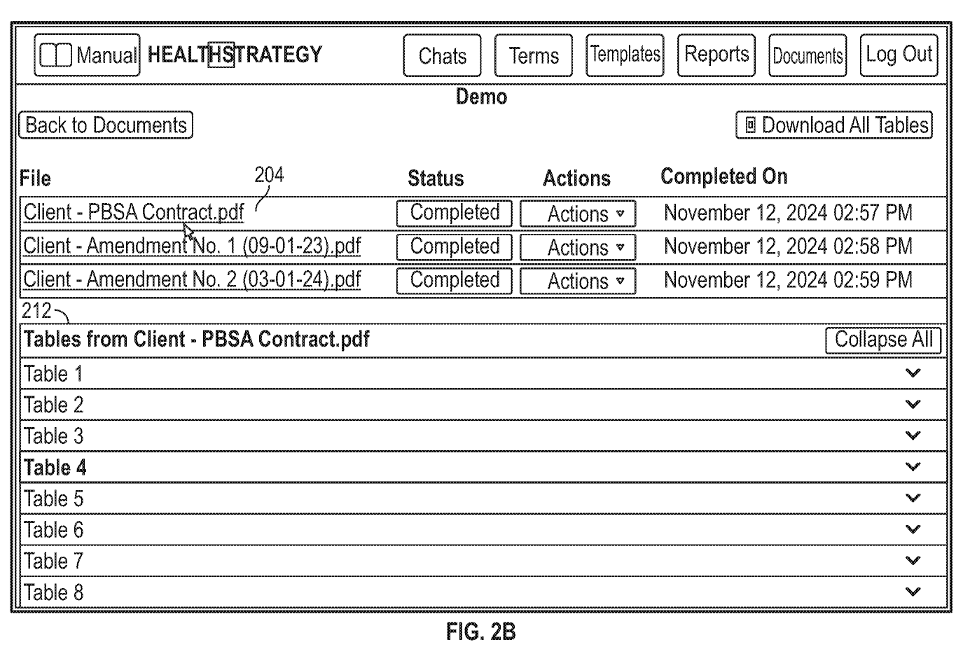

FIG. 2 illustrates an example template 202 for selecting one or more categories to perform the contract vulnerability analysis according to some aspects of the disclosure.

During the execution of contract vulnerability analysis, the user can select a template 202 via an integrated software application that houses a database containing industry-specific definitions, financial terms, preferred language, pharmacy claim types, and best practices. In certain implementations, users can create custom templates that guide the LLM's analysis process. During template 202 creation, users can specify particular definitions, terms, and exclusion types for analysis and include general questions for the LLM to address later in the process using the contract's context.

Users have the capability to customize templates by defining specific financial terms 204, term definitions 206, and excluded claims 208 relevant to a particular contractual agreement. Additionally, users can input general questions 210 for the LLM to generate responses. For example, a user might ask the LLM, "Does this contract comply with our organization's standard terms for reimbursement claims?" or "How is a rebate defined in the contract?" or "What are the requirements for data file exchange?" The LLM would then analyze the contract and deliver a contextually supported response for each inquiry.

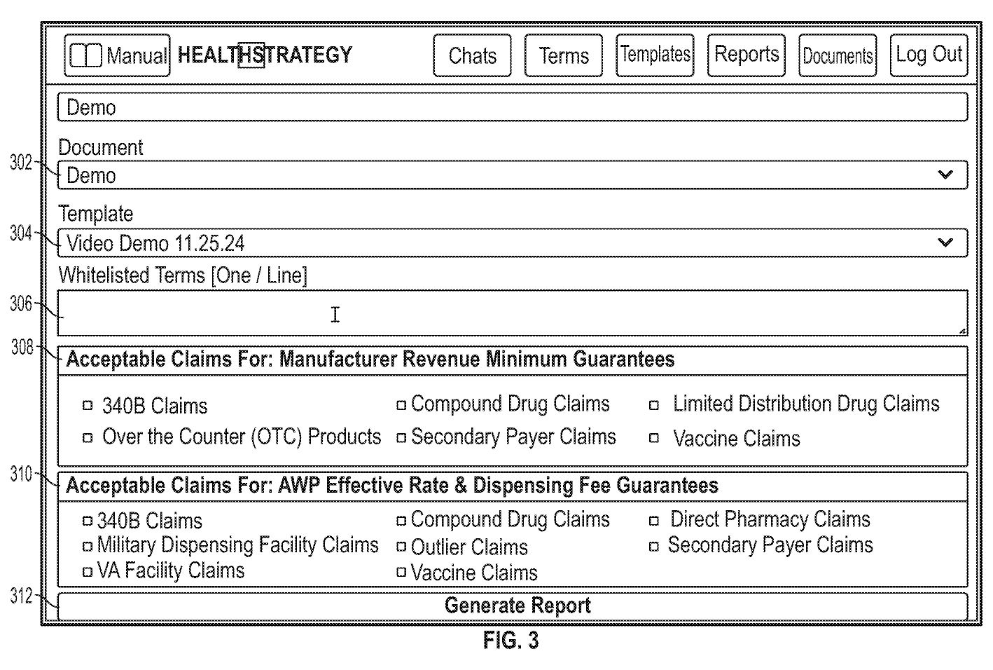

FIG. 3 illustrates an example executed summary of a contract vulnerability analysis report 300 according to some aspects of the disclosure.

Upon receiving a user selection that includes both a template and a collection via the user interface of the software application, the computing system can initiate the generation of analysis report 300. The software application can first query the vector database using embeddings that reflect an organization's best practices for each specified item in the selected template. This query can retrieve the relevant language in the document corresponding to the requested criteria. Additionally, the search can identify semantically similar language, particularly in cases where contracts have undergone multiple amendments. The language retrieved from the contract and the relevant context and instructions are then transmitted to a large language model (LLM) hosted on AWS for further processing.

In some examples, the computing system can recognize the chronological order of one or more terms in agreements of varying size, ensuring that any redefined terms are given precedence and applied consistently throughout the entire contractual agreement. For example, the LLM can identify that a document includes one or more amendments to its content, such as changes to specific terms within the contract. The LLM then associates these amended terms with predefined terms from the set of analysis characteristics, where each predefined term is assigned a priority level. Based on this priority level, the LLM assigns a relevance score to the amended terms, reflecting their importance within the overall analysis framework.

The LLM, utilizing the retrieved language, generates insights tailored to specific categories within the contract. The generated insights can include a vulnerability score 302 indicates how the document or contractual agreement performed, and a comparison of how many of the terms were protected terms or unprotected terms.

For definitions, the can LLM conduct a discrepancy analysis that compares any additions, omissions, or changes between the language found in the contract and the company's best practices that are defined with a set of analysis characteristics defined in the predefined template. By performing this analysis, the LLM can identify any deviations that may affect the contract's integrity. In some examples, the LLM can generate insights that include a term definitions analysis 304 and financial terms analysis 306 that compares protected and unprotected terms utilized within the uploaded contractual agreement.

For exclusions defined in the template, the computing system can cross-reference text containing excluded claims against a predefined list of acceptable exclusions, systematically categorizing them into insightful buckets that offer a clear view of compliance or potential risks. Upon performing the analysis of the contractual agreement based on the template selected, the LLM can generates insights that include excluded claims analysis 308, that compares protected and unprotected terms utilized within the contractual agreement.

Additionally, for general questions specified in the template, the LLM can generate precise answers based on the relevant context extracted from the contract. These analyses are then compiled into a contract vulnerability analysis report 300, as shown in FIG. 3, which can be viewed, printed, edited, or deleted within the software application.

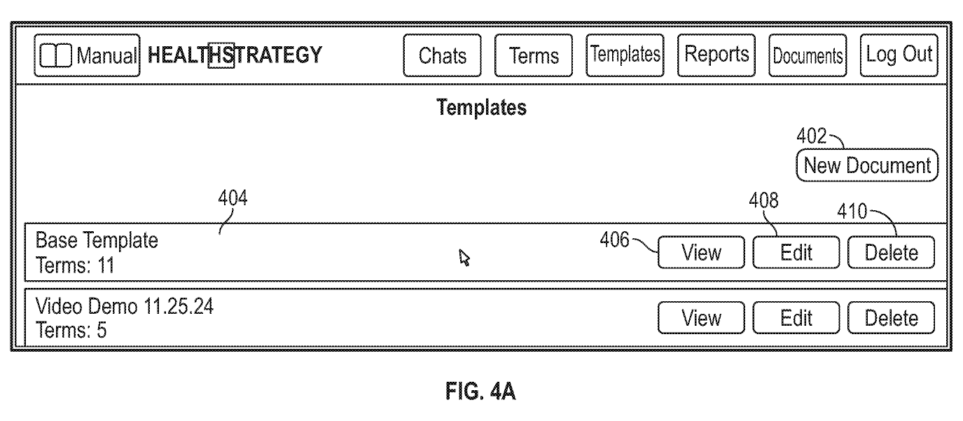

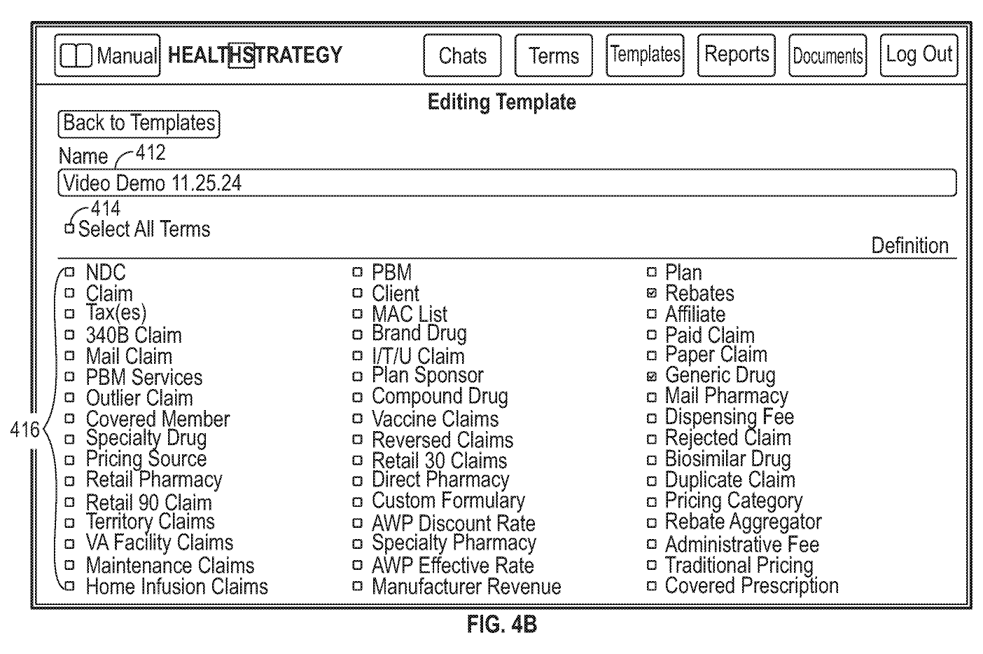

FIG. 4 illustrates an example report generated by the computing system according to some aspects of the disclosure.

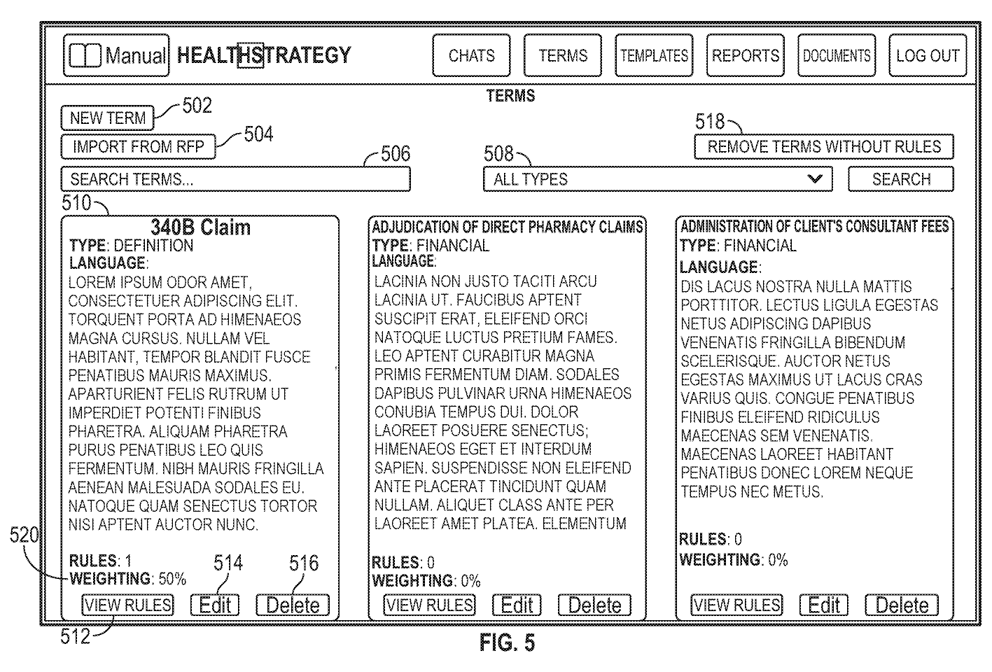

The computing system via the integrated software application can generate a report 400 based on the insights provided by the LLM. This report can include a detailed scope of analysis 402, including the full contractual agreement, which can be accessed directly through a clickable link for download and reference. It features a summary of findings 404, detailing the insights derived from the LLM’s analysis, along with proposed recommendations and remedial actions are needed to address any deficiencies identified. Additionally, the report 400 can include a table of contents 406 with hyperlinks to specific sections of the analysis report 300, as illustrated in FIG. 3. The table of contents 406 includes detailed evaluations such as term definitions report, financial terms report, and an exclusion report that highlights excluded claims not in compliance with the template, along with LLM responses to general questions specified in the selected template. Each of these sections will be further elaborated in FIG. 5 through FIG. 7.

FIG. 5 illustrates the financial terms report of the contract vulnerability analysis according to some aspects of the disclosure.

Based on the insights provided by the LLM, the software application generates a detailed financial terms report 500. This report includes a comprehensive list of financial terms 502 extracted from the document, each accompanied by similarity score 504. The similarity score 504 is derived from the LLM’s analysis of the document’s content, comparing the extracted financial terms against those specified in the selected template. The LLM evaluates sections of the document to identify terms that match or are similar to the predefined terms in the template. This comparison determines whether the financial terms in the document are correctly, contextually, and quantitatively aligned with those outlined in the template. The similarity score 504 reflects the degree of alignment, providing a quantifiable measure of how well the document adheres to the template.

In some examples, if the LLM analysis reveals that financial terms specified in the template, which are relevant to the uploaded document or contractual agreement, are missing, the financial terms report 500 can include a list of these excluded financial terms 506. The excluded financial terms 506 list highlights the financial terms from the template that were expected but not found within the document. By clearly delineating these excluded terms, the financial terms report 500 can provide insights into gaps between the template’s requirements and the actual content of the document determined by the LLM.

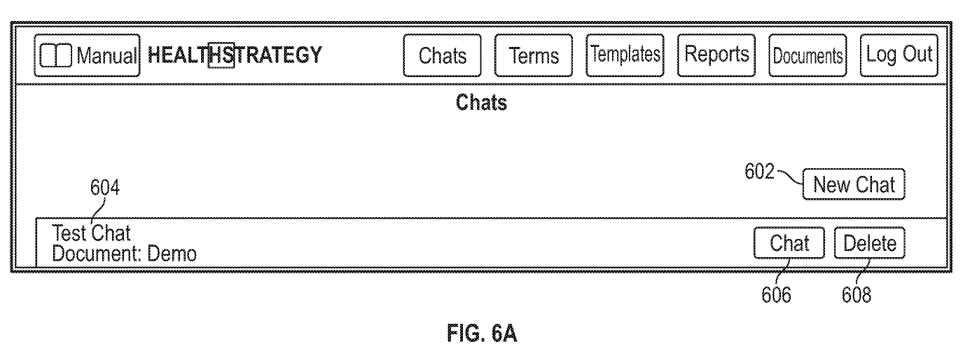

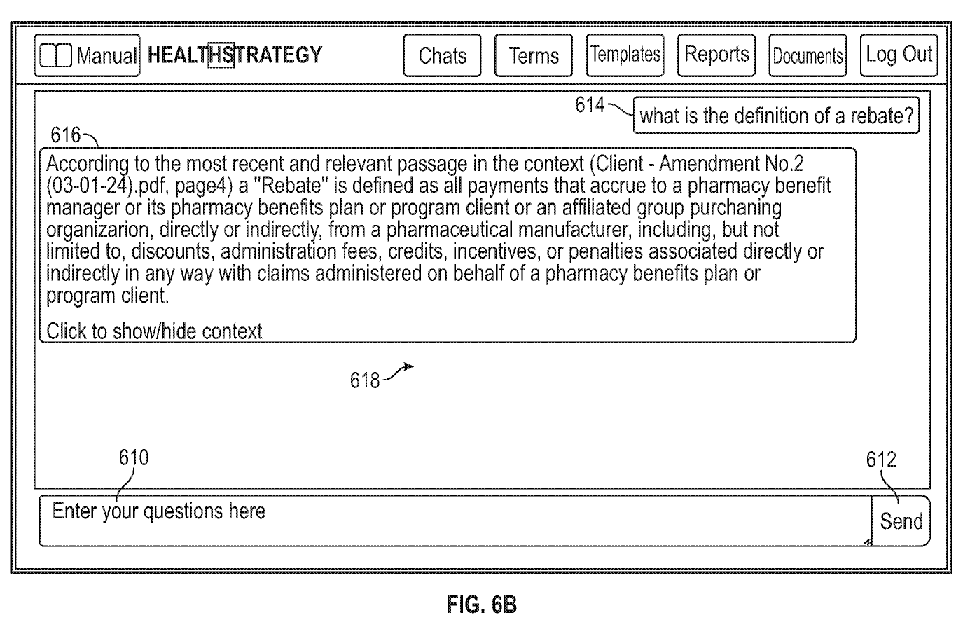

FIG. 6 illustrates an example output for the contract vulnerability analysis of one or more definitions selected from the analysis categories according to some aspects of the disclosure.

The term definitions report 600 includes key elements such as a similarity score 602, the definition found within the contract language, and an analysis of any discrepancies between the contract language and the organization's preferred definitions. The computing system generates the term definitions report 600 based on the insights generated by the LLM. The similarity score 602, as shown in FIG. 6, quantifies the match between the contract’s definition and the preferred definition from the template, expressed as a percentage. For example, the term "Retail 30 Claim" in the contract is shown to have a similarity score of 94%, indicating a strong alignment with the preferred definition. This similarity score is presented alongside the exact wording of the definition as it appears in the uploaded contract, providing users with a side-by-side comparison to assess any potential discrepancies.

Additionally, the term definitions report 600 includes a discrepancy analysis 604, which describes the differences contributing to the similarity score 602. This analysis meticulously identifies and highlights the discrepancies between the preferred language outlined in the template and the actual language found in the contractual agreement. By analyzing these differences, the report clarifies how the contract's definitions diverge from the organization's norms. This focused insight ensures that all terms align with the established best practices, thereby mitigating potential risks associated with non-compliance or misinterpretation of contractual language. Thus, based on the similarity score 602 and discrepancy analysis 604, a user can evaluate whether contract language amendments are necessary to comply with the designated definitions fully.

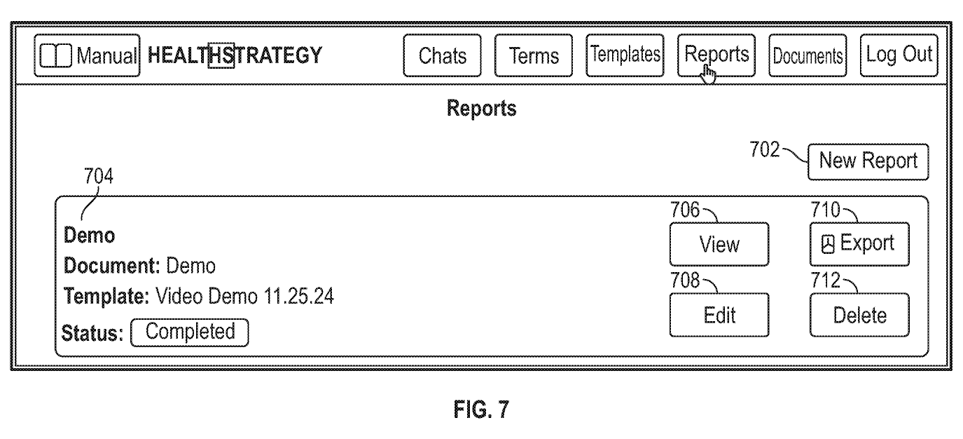

FIG. 7 illustrates an example of an exclusion report 700 according to some aspects of the disclosure.

Exclusion report 700 generated by the computing system from the insights provided by the LLM, delivers an analysis of excluded claims identified within the contractual agreement. This exclusion report 700 includes a summary that categorizes these claims into predefined "buckets" based on the criteria outlined in the selected template. The LLM can determine a bucket grade 702 based on whether terms extracted from the contractual agreement are in conformance with buckets in the selected template. For example, a bucket may comprise claims related to pharmacy rebates explicitly excluded from reimbursement but deemed acceptable according to the selected template predefined claims. Exclusion report 700 systematically organizes these excluded claims into distinct categories, including defined exclusions 704, acceptable exclusions 706, acceptable and defined exclusions 708, and neither acceptable or defined exclusions 710, depending on whether the exclusions align with the terms defined in the template and are explicitly mentioned in the text of the contractual agreement.

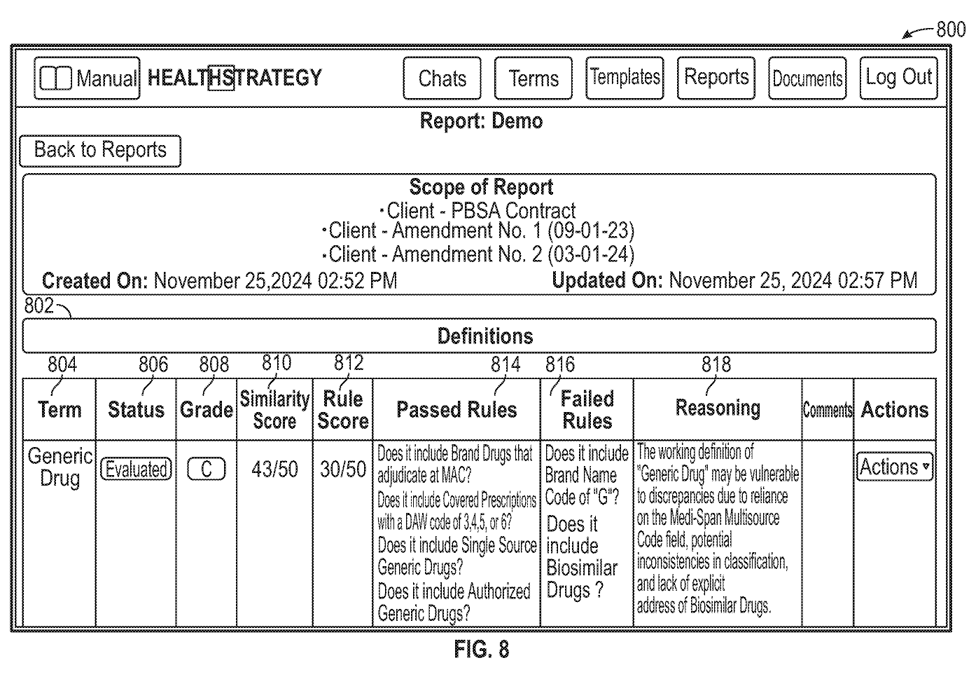

FIG. 8 illustrates an example response to a natural language question using context from the contract language according to some aspects of the disclosure.

In some examples, during the contract vulnerability analysis, natural language questions embedded within the selected template are meticulously analyzed by the LLM to provide precise, contextually relevant insights. For example, as shown in FIG. 8, a template may include a question such as, “What are the conditions for termination of the contract?” As the LLM processes the contractual agreement, the LLM interprets this inquiry within the template by examining the textual language within the contractual agreement and aligning it with the organization's predefined best practices defined in the template. The LLM then generates an analysis, identifying whether the contract's terms and clauses are in compliance with the selected template. The response from the LLM not only answers the question but also includes supporting context drawn directly from the contract, offering a detailed explanation of how the conclusions were reached.

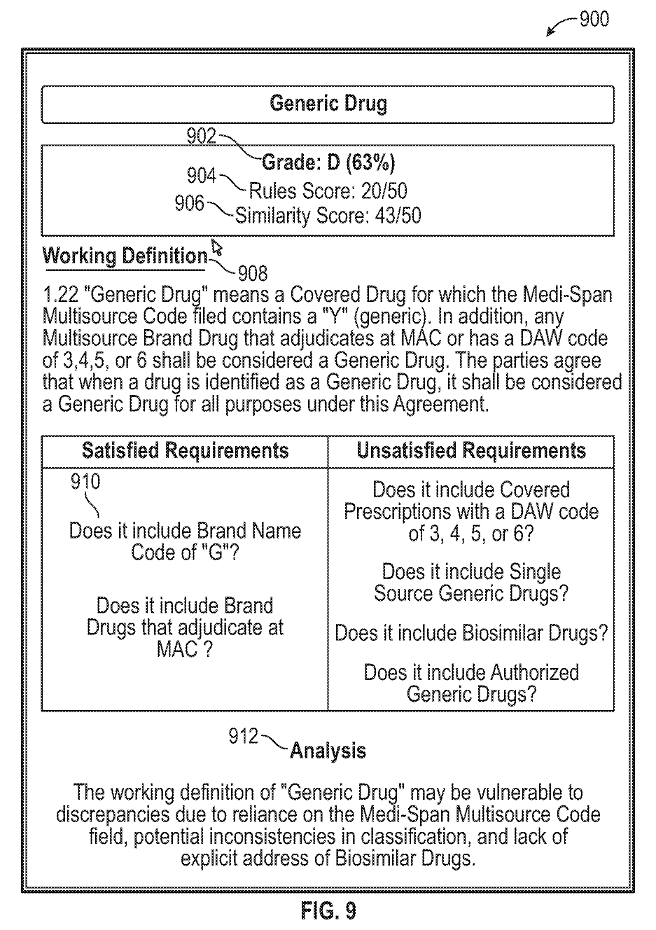

FIG. 9 illustrates an example of a chat output in response to natural language questions within a chat session according to some aspects of the disclosure.

In some examples, a chatbot is integrated into the software application to serve as an interactive interface for receiving and responding to natural language questions from users or stakeholders via chat sessions. For example, a user might initiate a chat session 900 by typing the inquiry, "How are rebates defined in this contract?" The LLM processes this input by analyzing the relevant sections of the contractual agreement to identify clauses that define rebates. The LLM then returns a detailed response within the chat session, pinpointing the specific clauses and providing an explanation of how rebates are defined within the contract.

In another instance, the user may follow up with a question including, "Are data file exchange requirements mentioned in the contract?" The LLM once again performs a targeted contract vulnerability analysis, scanning the document for any references to data file exchange requirements. It then delivers a comprehensive response within the chat session 900, highlighting the relevant sections of the contract, detailing the content of the clauses, and explaining their implications.

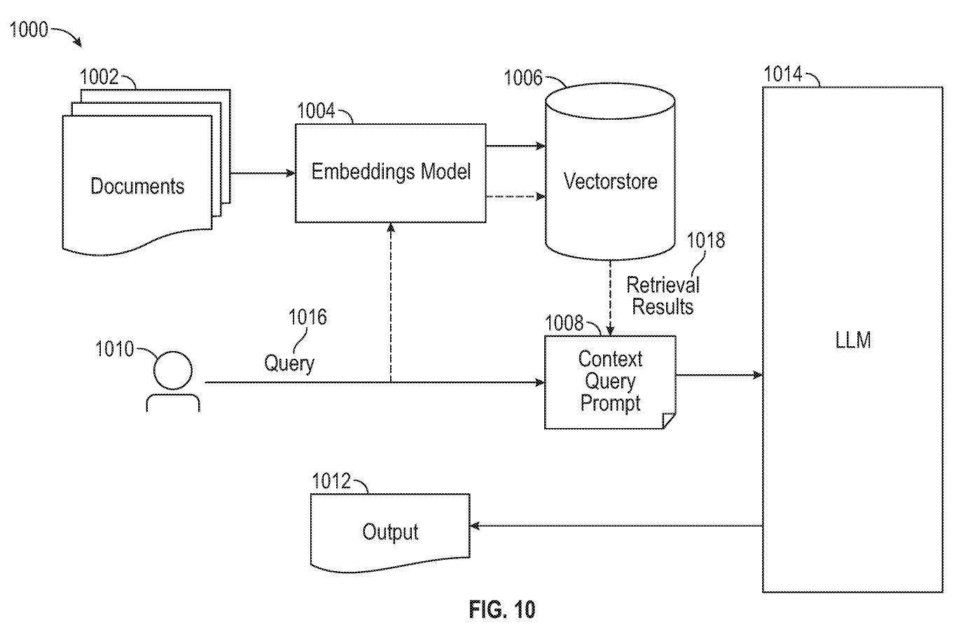

FIG. 10 is a block diagram illustrating an example machine learning platform for implementing various aspects of this disclosure in accordance with some embodiments of the present technology. Although the example system depicts particular system 1000 components and an arrangement of such components, this depiction is to facilitate a discussion of the present technology and should not be considered limiting unless specified in the appended claims. For example, some components that are illustrated as separate can be combined with other components, and some components can be divided into separate components.

System 1000 may include data input engine 1010 that can further include data retrieval engine 1012 and data transform engine 1014. Data retrieval engine 1012 may be configured to access, interpret, request, or receive data, which may be adjusted, reformatted, or changed (e.g., to be interpretable by another engine, such as data input engine 1010). For example, data retrieval engine 1012 may request data from a remote source using an API. Data input engine 1010 may be configured to access, interpret, request, format, re-format, or receive input data from data sources(s) 1001. For example, data input engine 1010 may be configured to use data transform engine 1014 to execute a re-configuration or other change to data, such as a data dimension reduction. In some embodiments, data sources(s) 1001 may be associated with a single entity (e.g., organization) or with multiple entities. Data sources(s) 1001 may include one or more of training data 1002a (e.g., input data to feed a machine learning model as part of one or more training processes), validation data 1002b (e.g., data against which at least one processor may compare model output with, such as to determine model output quality), and/or reference data 1002c. In some embodiments, data input engine 1010 can be implemented using at least one computing device. For example, data from data sources(s) 1001 can be obtained through one or more I/O devices and/or network interfaces. Further, the data may be stored (e.g., during execution of one or more operations) in a suitable storage or system memory. Data input engine 1010 may also be configured to interact with a data storage, which may be implemented on a computing device that stores data in storage or system memory.

System 1000 may include featurization engine 1020. Featurization engine 1020 may include feature annotating & labeling engine 1022 (e.g., configured to annotate or label features from a model or data, which may be extracted by feature extraction engine 1024), feature extraction engine 1024 (e.g., configured to extract one or more features from a model or data), and/or feature scaling & selection engine 1026 Feature scaling & selection engine 1026 may be configured to determine, select, limit, constrain, concatenate, or define features (e.g., AI features) for use with AI models.

System 1000 may also include machine learning (ML) ML modeling engine 1030, which may be configured to execute one or more operations on a machine learning model (e.g., model training, model re-configuration, model validation, model testing), such as those described in the processes described herein. For example, ML modeling engine 1030 may execute an operation to train a machine learning model, such as adding, removing, or modifying a model parameter. Training of a machine learning model may be supervised, semi-supervised, or unsupervised. In some embodiments, training of a machine learning model may include multiple epochs, or passes of data (e.g., training data 1002a) through a machine learning model process (e.g., a training process). In some embodiments, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed embodiments in any way, a machine learning model may include millions, billions, or even trillions of model parameters. ML modeling engine 1030 may include model selector engine 1032 (e.g., configured to select a model from among a plurality of models, such as based on input data), parameter engine 1034 (e.g., configured to add, remove, and/or change one or more parameters of a model), and/or model generation engine 1036 (e.g., configured to generate one or more machine learning models, such as according to model input data, model output data, comparison data, and/or validation data).

In some embodiments, model selector engine 1032 may be configured to receive input and/or transmit output to ML algorithms database 1070. Similarly, featurization engine 1020 can utilize storage or system memory for storing data and can utilize one or more I/O devices or network interfaces for transmitting or receiving data. ML algorithms database 1070 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein. Two specific examples of machine learning models that can be stored in the ML algorithms database 1070 include versions DALL·E and CHAT GPT, both provided by OPEN AI.

System 1000 can further include generative response engine 1040 that is made up of a predictive output generation engine 1045, output validation engine 1050 (e.g., configured to apply validation data to machine learning model output). Predictive output generation engine 1045 can be configured to receive inputs from front end 1072 that provide some guidance as to a desired output. Front end 1072 can be a graphical user interface where a user can provide natural language prompts and receive responses from generative response engine 1040. Front end 1072 can also be an application programming interface (API) which other applications can call by providing a prompt and can receive responses from generative response engine 1040. Predictive output generation engine 1045 can analyze the input and identify relevant patterns and associations in the data it has learned to generate a sequence of words that predictive output generation engine 1045 predicts is the most likely continuation of the input using one or more models from the ML algorithms database 1070, aiming to provide a coherent and contextually relevant answer. Predictive output generation engine 1045 generates responses by sampling from the probability distribution of possible words and sequences, guided by the patterns observed during its training. In some embodiments, predictive output generation engine 1045 can generate multiple possible responses before presenting the final one. Predictive output generation engine 1045 can generate multiple responses based on the input, and these responses are variations that predictive output generation engine 1045 considers potentially relevant and coherent. Output validation engine 1050 can evaluate these generated responses based on certain criteria. These criteria can include relevance to the prompt, coherence, fluency, and sometimes adherence to specific guidelines or rules, depending on the application. Based on this evaluation, output validation engine 1050 selects the most appropriate response. This selection is typically the one that scores highest on the set criteria, balancing factors like relevance, informativeness, and coherence.

System 1000 can further include feedback engine 1060 (e.g., configured to apply feedback from a user and/or machine to a model) and model refinement engine 1055 (e.g., configured to update or re-configure a model). In some embodiments, feedback engine 1060 may receive input and/or transmit output (e.g., output from a trained, partially trained, or untrained model) to outcome metrics database 1065. Outcome metrics database 1065 may be configured to store output from one or more models and may also be configured to associate output with one or more models. In some embodiments, outcome metrics database 1065, or other device (e.g., model refinement engine 1055 or feedback engine 1060), may be configured to correlate output, detect trends in output data, and/or infer a change to input or model parameters to cause a particular model output or type of model output. In some embodiments, model refinement engine 1055 may receive output from predictive output generation engine 1045 or output validation engine 1050. In some embodiments, model refinement engine 1055 may transmit the received output to featurization engine 1020 or ML modeling engine 1030 in one or more iterative cycles.

The engines of system 1000 may be packaged functional hardware units designed for use with other components or a part of a program that performs a particular function (e.g., of related functions). Any or each of these modules may be implemented using a computing device. In some embodiments, the functionality of system 1000 may be split across multiple computing devices to allow for distributed processing of the data, which may improve output speed and reduce computational load on individual devices. In some embodiments, system 1000 may use load-balancing to maintain stable resource load (e.g., processing load, memory load, or bandwidth load) across multiple computing devices and to reduce the risk of a computing device or connection becoming overloaded. In these or other embodiments, the different components may communicate over one or more I/O devices and/or network interfaces.

System 1000 can be related to different domains or fields of use. Descriptions of embodiments related to specific domains, such as natural language processing or language modeling, is not intended to limit the disclosed embodiments to those specific domains, and embodiments consistent with the present disclosure can apply to any domain that utilizes predictive modeling based on available data.

The system 1000 may include various types of ML models, such as a transformer. A transformer is a neural network architecture built into natural language processing (NLP) tasks, such as language translation, sentiment analysis, and text summarization. Conventional traditional recurrent neural networks (RNNs) process data in sequence, which slows the operations and training. A transformer or transformer network can process input in parallel and is faster and more efficient than sequential training and processing. In some aspects, transformers use a self-attention mechanism, which allows a transformer to identify the most relevant parts of the input text or content (e.g., audio or video). In some cases, transformers can also use a cross-attention mechanism which uses other content or data to determine the most relevant parts of the input. For example, cross-attention mechanisms are useful in sequential content such as a stream of data, such as optical flow, and other computer vision techniques.

A transformer model includes a multi-layer encoder-decoder architecture. The encoder takes the input text, converts the input text into a sequence of hidden representations and captures the meaning of the text at different levels of abstraction. The decoder then uses these representations to generate an output sequence, such as a text translation or a summary. The encoder and decoder are trained together using a combination of supervised and unsupervised learning techniques, such as maximum likelihood estimation and self-supervised pretraining. Illustrative examples of transformer engines include a Bidirectional Encoder Representations from Transformers (BERT) model, a Text-to-Text Transfer Transformer (T5), biomedical BERT (BioBERT), scientific BERT (SciBERT), and the SPECTER model for document-level representation learning. In some aspects, multiple transformer engines may be used to generate different embeddings.

An embedding is a representation of a discrete object, such as a word, a document, or an image, as a continuous vector in a multi-dimensional space. An embedding captures the semantic or structural relationships between the objects, such that similar objects are mapped to nearby vectors, and dissimilar objects are mapped to distant vectors. Embeddings are commonly used in machine learning, computer vision, and natural language processing tasks, such as language modeling, sentiment analysis, and machine translation. Embeddings are typically learned from large corpora of data using unsupervised learning algorithms, such as word2vec, GloVe, or fastText, which optimize the embeddings based on the co-occurrence or context of the objects in the data. Once learned, embeddings can be used to improve the performance of downstream tasks by providing a more meaningful and compact representation of the objects.

In some aspects, a generative response engine can be used in conjunction with supplemental models, such as a generator and a discriminator, which together form a GAN. A generator model generates data samples that resemble the distribution of a given dataset. For example, the generator takes random noise as input and transforms the noise into data samples that are indistinguishable from real data. The generator learns to produce realistic samples through training, often using techniques such as backpropagation and gradient descent, and is used for various applications, including image synthesis, text generation, and data augmentation. A discriminator is configured to distinguish between real data samples and fake or generated data samples produced by the generator. The discriminator learns to differentiate between real and generated data, providing feedback to the generator. In some cases, a discriminator can be trained in different contexts to differentiate between different safe and unsafe content.

In some aspects, the predictive output generation engine 1045 may be executed using a neural engine for on-device execution. A neural engine that includes a plurality of neural processing cores that are configured to parallelize operations associated with neural networks. A neural processing core includes arrays of multiply-accumulate (MAC) units and specialized instructions that are optimized for matrix operations, such as convolution and matrix multiplication. A neural processing core receives input data and performs matrix transformations and nonlinear activation functions to break down and parallelize matrix operations. The neural processing core is configured to perform tasks such as inference (e.g., runtime operation of an ML model) or training of deep learning models and accelerates tasks by parallelization of larger computations that can be performed in parallel (e.g., matrix operations associated with neural networks). For example, a neural engine may perform computer vision tasks such as object recognition. In some cases, the neural engine can be implemented based on various ML libraries such as PyTorch, which interfaces with the compute unified device architecture (CUDA) to parallelize operations.

In one example, the predictive output generation engine 1045 may be a small generative model that has fewer parameters, fewer layers, fewer neurons, or a simpler architecture compared to larger models. A small generative model may not capture the full complexity of the underlying data distribution as effectively as larger models but can still be useful in scenarios where computational resources are limited or where a simpler model is sufficient for the task. Small generative models can also be easier to train and interpret, making them suitable for certain applications. For example, ChatGPT-3.5 has 175 billion parameters and would result in a size of 1.4 Terabytes (TB) for a model implemented with double-precision floating point numbers. A smaller model may have a simpler architecture, use fewer parameters (e.g., 10 million), and use less precise numbers (e.g., single-precision floating point numbers) resulting in a size of 38 Megabytes (MB).

In addition, small models benefit from increased training based on local execution and data specific to a local device and a user of that local device. An additional benefit to small models is increased privacy because information is not transmitted over the network and only relies on information requested by the user or usage at the local device.

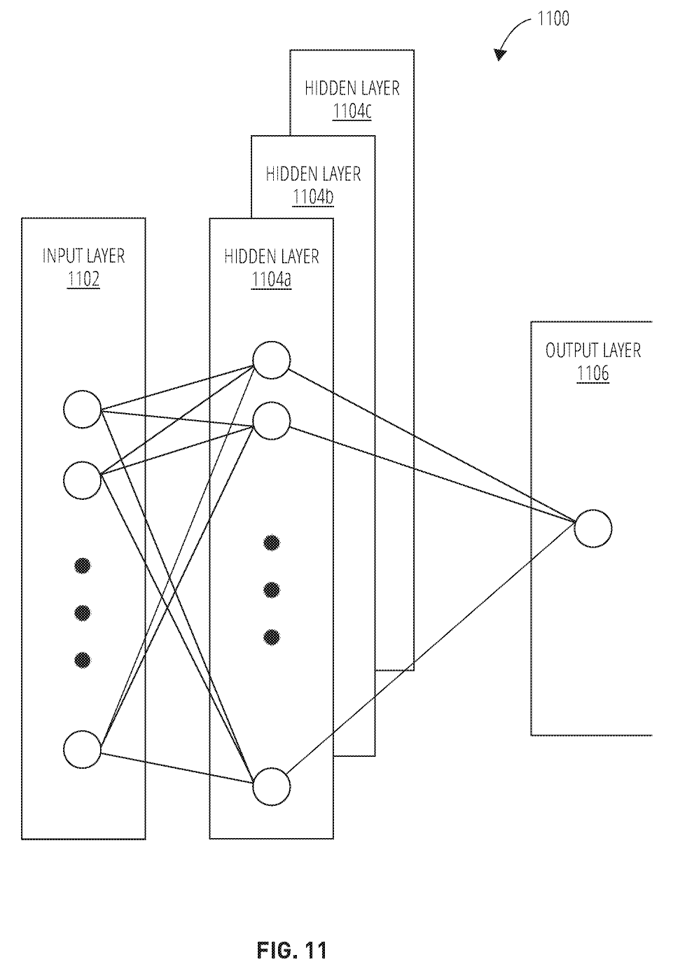

FIG. 11 illustrates an example lifecycle 1100 of a ML model in accordance with some examples. The first stage of the lifecycle 1100 of a ML model is a data ingestion service 1102 to generate datasets described below. ML models require a significant amount of data for the various processes described in FIG. 2 and the data persisted without undertaking any transformation to have an immutable record of the original dataset. The data can be provided from third party sources such as publicly available dedicated datasets. The data ingestion service 1102 provides a service that allows for efficient querying and end-to-end data lineage and traceability based on a dedicated pipeline for each dataset, data partitioning to take advantage of the multiple servers or cores, and spreading the data across multiple pipelines to reduce the overall time to reduce data retrieval functions.

In some cases, the data may be retrieved offline that decouples the producer of the data from the consumer of the data (e.g., an ML model training pipeline). For offline data production, when source data is available from the producer, the producer publishes a message and the data ingestion service 1102 retrieves the data. In some examples, the data ingestion service 1102 may be online and the data is streamed from the producer in real-time for storage in the data ingestion service 1102.

After data ingestion service 1102, a data preprocessing service preprocesses the data to prepare the data for use in the lifecycle 1100 and includes at least data cleaning, data transformation, and data selection operations. The data cleaning and annotation service 1104 removes irrelevant data (data cleaning) and general preprocessing to transform the data into a usable form. The data cleaning and annotation service 1104 includes labeling of features relevant to the ML model. In some examples, the data cleaning and annotation service 1104 may be a semi-supervised process performed by a ML to clean and annotate data that is complemented with manual operations such as labeling of error scenarios, identification of untrained features, etc.

After the data cleaning and annotation service 1104, data segregation service 1106 to separate data into at least a training set 1108, a validation dataset 1110, and a test dataset 1112. Each of the training set 1108, a validation dataset 1110, and a test dataset 1112 are distinct and do not include any common data to ensure that evaluation of the ML model is isolated from the training of the ML model.

The training set 1108 is provided to a model training service 1114 that uses a supervisor to perform the training, or the initial fitting of parameters (e.g., weights of connections between neurons in artificial neural networks) of the ML model. The model training service 1114 trains the ML model based a gradient descent or stochastic gradient descent to fit the ML model based on an input vector (or scalar) and a corresponding output vector (or scalar).

After training, the ML model is evaluated at a model evaluation service 1116 using data from the validation dataset 1110 and different evaluators to tune the hyperparameters of the ML model. The predictive performance of the ML model is evaluated based on predictions on the validation dataset 1110 and iteratively tunes the hyperparameters based on the different evaluators until a best fit for the ML model is identified. After the best fit is identified, the test dataset 1112, or holdout data set, is used as a final check to perform an unbiased measurement on the performance of the final ML model by the model evaluation service 1116. In some cases, the final dataset that is used for the final unbiased measurement can be referred to as the validation dataset and the dataset used for hyperparameter tuning can be referred to as the test dataset.

After the ML model has been evaluated by the model evaluation service 1116, an ML model deployment service 1118 can deploy the ML model into an application or a suitable device. The deployment can be into a further test environment such as a simulation environment, or into another controlled environment to further test the ML model.

After deployment by the ML model deployment service 1118, a performance monitor service 1120 monitors for performance of the ML model. In some cases, the performance monitor service 1120 can also record additional transaction data that can be ingested via the data ingestion service 1102 to provide further data, additional scenarios, and further enhance the training of ML models.

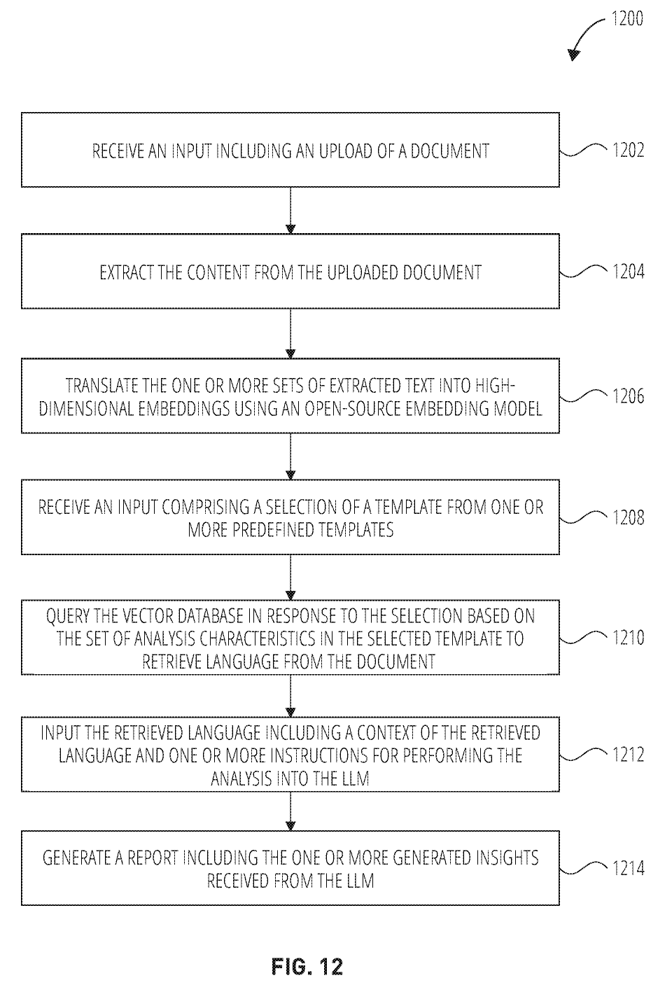

In FIG. 12, the disclosure now turns to a further discussion of models that can be used through the environments and techniques described herein. Specifically, FIG. 12 is an illustrative example of a deep learning neural network 1200 that can be used to implement all or a portion of a generative response engine. The neural network 1200 includes multiple hidden layers 1204a, 1204b, through 1204c. The hidden layers 1204a through 1204c include “n” number of hidden layers, where “n” is an integer greater than or equal to one. The number of hidden layers can be made to include as many layers as needed for the given application. The neural network 1200 further includes an output layer 1206 that provides an output resulting from the processing performed by the hidden layers 1204a through 1204c. In one illustrative example, the output layer 1206 can provide estimated treatment parameters, which can be used/ingested by a differential simulator to estimate a patient treatment outcome.

The neural network 1200 is a multi-layer neural network of interconnected nodes. Each node can represent a piece of information. Information associated with the nodes is shared among the different layers and each layer retains information as information is processed. In some cases, the neural network 1200 can include a feed-forward network, in which case there are no feedback connections where outputs of the network are fed back into itself. In some cases, the neural network 1200 can include a recurrent neural network, which can have loops that allow information to be carried across nodes while reading in input.

Information can be exchanged between nodes through node-to-node interconnections between the various layers. Nodes of the input layer 1202 can activate a set of nodes in the first hidden layer 1204a. For example, as shown, each of the input nodes of the input layer 1202 is connected to each of the nodes of the first hidden layer 1204a. The nodes of the first hidden layer 1204a can transform the information of each input node by applying activation functions to the input node information. The information derived from the transformation can then be passed to and can activate the nodes of the next hidden layer 1204b, which can perform their own designated functions. Example functions include convolutional, up-sampling, data transformation, and/or any other suitable functions. The output of the hidden layer 1204b can then activate nodes of the next hidden layer, and so on. The output of the last hidden layer 1204c can activate one or more nodes of the output layer 1206, at which an output is provided. In some cases, while nodes in the neural network 1200 are shown as having multiple output lines, a node can have a single output and all lines shown as being output from a node represent the same output value.

In some cases, each node or interconnection between nodes can have a weight that is a set of parameters derived from the training of the neural network 1200. Once the neural network 1200 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 1200 to be adaptive to inputs and able to learn as more data is processed.

The neural network 1200 is pre-trained to process the features from the data in the input layer 1202 using the different hidden layers 1204a through 1204c in order to provide the output through the output layer 1206.

In some cases, the neural network 1200 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 1200 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total = ∑(1/2 (target-output)^2). The loss can be set to be equal to the value of E_total.

The loss (or error) will be high for the initial training data since the actual values will be much different than the predicted output. The goal of training is to minimize the amount of loss so that the predicted output is the same as the training output. The neural network 1200 can perform a backward pass by determining which inputs (weights) most contributed to the loss of the network, and can adjust the weights so that the loss decreases and is eventually minimized.

The neural network 1200 can include any suitable deep network. One example includes a large language model (LLM), which is based on a transformer architecture of deep learning neural network. Another example is a convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 1200 can include any other deep network other than an LLM or CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

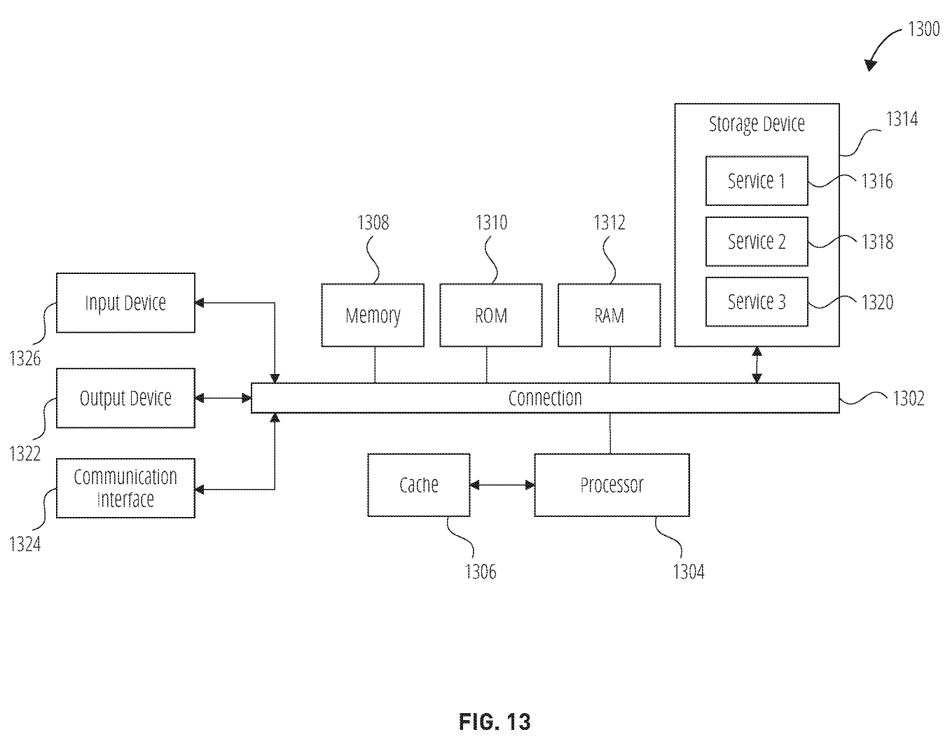

FIG. 13 illustrates an example process 1300 for performing contract vulnerability analysis by an LLM. Although the example process 1300 depicts a particular sequence of operations, the sequence may be altered without departing from the scope of the present disclosure. For example, some of the operations depicted may be performed in parallel or in a different sequence that does not materially affect the function of the process 1300. In other examples, different components of an example device or system that implements the process 1300 may perform functions at substantially the same time or in a specific sequence.

According to some examples, the method includes receiving an input including an upload of a document at block 1302. For example, the computing system 1400 depicted in FIG. 14 may receive an input that includes the upload of a document containing content for analysis by the LLM. The uploaded document is securely stored in Amazon Simple Storage Service (AWS S3), providing scalable and reliable storage.

According to some examples, the method includes extracting the content from the uploaded document at block 1304. For example, the computing system 1400 shown in FIG. 14 may extract content from the uploaded document, ensuring the preservation of its integrity across one or more sets of extracted text. This process involves extracting various text layouts, paragraphs, lists, continuous statements, and tables from the uploaded document.

According to some examples, the method includes translating the one or more sets of extracted text into high-dimensional embeddings using an open-source embedding model at block 1306. For example, the computing system 1400 depicted in FIG. 14 may convert the extracted text into high-dimensional embeddings using an open-source embedding model. Both the high-dimensional embeddings and the extracted text are then stored in a vector database. This vector database organizes the embeddings and text into one or more collections, facilitating semantic search and retrieval of relevant information upon request.

According to some examples, the method includes receiving an input comprising a selection of a template from one or more predefined templates at block 1308. For example, the computing system 1400 shown in FIG. 14 may receive an input that includes selecting a template from one or more predefined templates. Each template contains a set of analysis characteristics for evaluating the content of the uploaded document, as well as one or more inquiries for the LLM to analyze using contextual information from the document. The analysis characteristics encompass various categories, including definitions, terms, and exclusion types, which are used to compare the document's content against a predefined dataset of organizational best practices.

According to some examples, the method includes querying the vector database in response to the selection based on the set of analysis characteristics in the selected template to retrieve language from the document at block 1310. For example, the computing system 1400 depicted in FIG. 14 may query the vector database based on the set of analysis characteristics specified in the selected template. This query retrieves relevant language from the document by identifying semantically similar terms and phrases that align with the defined analysis characteristics.

According to some examples, the method includes inputting the retrieved language including a context of the retrieved language and one or more instructions for performing the analysis into the LLM at block 1312. For example, the computing system 1400 illustrated in FIG. 14 may input the retrieved language including a context of the retrieved language and one or more instructions for performing the analysis into the LLM. The LLM is configured to generate one or more insights related to the content related to the set of analysis characteristics. The one or more insights including a vulnerability score and one or more recommendations to remediate the vulnerability score.

In some examples, the LLM can detect that the document contains one or more amendments to its content, specifically targeting amendments to certain terms. These amendments are then associated with predefined terms in the set of analysis characteristics, which includes priority levels for each term. Based on these priority levels, the system assigns a relevance score to each amendment. This score reflects how closely the amendments align with the predefined terms in the analysis set.

In some examples, the computing system can receive input through a chatbot integrated with the system, where the input consists of a natural language request containing one or more inquiries for additional analysis of the uploaded document's content. This request is processed by the LLM. The computing system then generates and outputs a response from the LLM, which includes context supporting the answer to the inquiry.

According to some examples, the method includes generating a report including the one or more generated insights received from the LLM at block 1314. For example, the computing system 1400 shown in FIG. 14 may generate a report based on the insights provided by the LLM. This report includes the calculated vulnerability score of the content along with one or more recommendations for addressing identified issues.

FIG. 14 shows an example of computing system 1400, which can be for example any computing device making up a system network, or any component thereof in which the components of the system are in communication with each other using connection 1402. Connection 1402 can be a physical connection via a bus, or a direct connection into processor 1404, such as in a chipset architecture. Connection 1402 can also be a virtual connection, networked connection, or logical connection.

In some embodiments, computing system 1400 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 1400 includes at least one processing unit (central processing unit (CPU) or processor) 1404 and connection 1402 that couples various system components including system memory 1408, such as read-only memory (ROM) 1410 and random access memory (RAM) 1412 to processor 1404. Computing system 1400 can include a cache 1406 of high-speed memory 1408 connected directly with, in close proximity to, or integrated as part of processor 1404.

Processor 1404 can include any general-purpose processor and a hardware service or software service, such as services 1416, 1418, and 1420 stored in storage device 1414, configured to control processor 1404, as well as a special-purpose processor where software instructions are incorporated into the actual processor design. Processor 1404 may essentially be a completely self-contained computing system, containing multiple cores or processors, a bus, memory controller, cache 1406, etc. A multi-core processor may be symmetric or asymmetric.

To enable user interaction, computing system 1400 includes an input device 1426, which can represent any number of input mechanisms, such as a microphone for speech, a touch-sensitive screen for gesture or graphical input, keyboard, mouse, motion input, speech, etc. Computing system 1400 can also include output device 1422, which can be one or more of a number of output mechanisms known to those of skill in the art. In some instances, multimodal systems can enable a user to provide multiple types of input/output to communicate with computing system 1400. Computing system 1400 can include communication interface 1424, which can generally govern and manage the user input and system output. There is no restriction on operating on any particular hardware arrangement, and therefore the basic features here may easily be substituted for improved hardware or firmware arrangements as they are developed.

Storage device 1414 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1414 can include software services, servers, services, etc., that when the code that defines such software is executed by the processor 1404, it causes the system to perform a function. In some embodiments, a hardware service that performs a particular function can include the software component stored in a computer-readable medium in connection with the hardware components, such as processor 1404, connection 1402, output device 1422, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for performing contract vulnerability analysis by a large language model (LLM), the method comprising:
receiving, by a computing system, an input including an upload of a document, the uploaded document comprising content for analysis by the LLM;
extracting, by the computing system, the content from the uploaded document, wherein the extraction is configured to preserve an integrity of the content into one or more sets of extracted text;
translating the one or more sets of extracted text into high-dimensional embeddings using an open-source embedding model, wherein the high-dimensional embeddings and the extracted text are stored in a vector database;
receiving, by the computing system, an input comprising a selection of a template from one or more predefined templates, each template comprising a set of analysis characteristics to utilize in the analysis of the content of the uploaded document, and one or more inquiries for the LLM to conduct the analysis using context from the content;
in response to the selection, querying the vector database based on the set of analysis characteristics in the selected template to retrieve language from the document, wherein the query identifies semantically similar language to the set of analysis characteristics;
inputting the retrieved language including a context of the retrieved language and one or more instructions for performing the analysis into the LLM, wherein the LLM is configured to generate one or more insights related to the content related to the set of analysis characteristics, the one or more insights including a vulnerability score and one or more recommendations to remediate the vulnerability score; and
generating, at the computing system, a report including the one or more generated insights received from the LLM, wherein the report includes the vulnerability score of the content and the one or more recommendations.

2. The method of claim 1, wherein the uploaded document is stored a scalable Amazon Simple Storage Service (AWS S3).

3. The method of claim 1, wherein the extracting includes the extraction of a plurality of text layouts, paragraphs, lists, continuous statements, and tables from the uploaded document.

4. The method of claim 1, wherein the vector database stores the high-dimensional embeddings and the extracted text in one or more collections allowing for processing of a semantic search and retrieval of relevant information upon receiving a request.

5. The method of claim 1, wherein the set of analysis characteristics includes a plurality of categories including one or more definitions, terms, and exclusion types for use in the analysis of the content of the uploaded document for comparison with a predefined data set of organizational best practices.

6. The method of claim 1, further comprising:
identifying, by the LLM, the document includes one or more amendments to content within the document, wherein the one or more amendments comprise an amendment to one or more terms in the document;
associating the amendment to the one or more terms with predefined terms in the set of analysis characteristics, wherein the set of analysis characteristics includes a priority level for each of the predefined terms; and
providing a relevance score to the amendment of the one or more terms based on the priority level in the set of analysis characteristics.

7. The method of claim 1, further comprising:
receiving, by the computing system, an input via a chatbot associated with the computing system, the input comprising a natural language request including one or more inquiries for further analysis of the content of the uploaded document to identify compliance with the set of analysis characteristics;
inputting the natural language request into the LLM for processing; and
outputting, by the computing system, a response generated by the LLM in response to the natural language request, wherein the response includes context supporting the response to the inquiry.

8. A system for performing contract vulnerability analysis by a large language model (LLM), the system comprising:
a memory and one or more processors that executes instructions stored in the memory, wherein the processor executes the instructions to:
receive an input including an upload of a document, the uploaded document comprising content for analysis by the LLM;
extract the content from the uploaded document, wherein the extraction is configured to preserve an integrity of the content into one or more sets of extracted text;
translate the one or more sets of extracted text into high-dimensional embeddings using an open-source embedding model, wherein the high-dimensional embeddings and the extracted text are stored in a vector database;
receive an input comprising a selection of a template from one or more predefined templates, each template comprising a set of analysis characteristics to utilize in the analysis of the content of the uploaded document, and one or more inquiries for the LLM to conduct the analysis using context from the content;
in response to the selection, query the vector database based on the set of analysis characteristics in the selected template to retrieve language from the document, wherein the query identifies semantically similar language to the set of analysis characteristics;
input the retrieved language including a context of the retrieved language and one or more instructions for performing the analysis into the LLM, wherein the LLM is configured to generate one or more insights related to the content related to the set of analysis characteristics, the one or more insights including a vulnerability score and one or more recommendations to remediate the vulnerability score; and
generate a report including the one or more generated insights received from the LLM, wherein the report includes the vulnerability score of the content and the one or more recommendations.

9. The system of claim 8, wherein the uploaded document is stored a scalable Amazon Simple Storage Service (AWS S3).

10. The system of claim 8, wherein the extracting includes the extraction of a plurality of text layouts, paragraphs, lists, continuous statements, and tables from the uploaded document.

11. The system of claim 8, wherein the vector database stores the high-dimensional embeddings and the extracted text in one or more collections allowing for processing of a semantic search and retrieval of relevant information upon receiving a request.

12. The system of claim 8, wherein the set of analysis characteristics includes a plurality of categories including one or more definitions, terms, and exclusion types for use in the analysis of the content of the uploaded document for comparison with a predefined data set of organizational best practices.

13. The system of claim 8, further comprising:
identifying, by the LLM, the document includes one or more amendments to content within the document, wherein the one or more amendments comprise an amendment to one or more terms in the document;
associating the amendment to the one or more terms with predefined terms in the set of analysis characteristics, wherein the set of analysis characteristics includes a priority level for each of the predefined terms; and
providing a relevance score to the amendment of the one or more terms based on the priority level in the set of analysis characteristics.

14. The system of claim 8, further comprising:
receiving an input via a chatbot, the input comprising a natural language request including one or more inquiries for further analysis of the content of the uploaded document to identify compliance with the set of analysis characteristics;
inputting the natural language request into the LLM for processing; and
outputting a generated response received from the LLM in response to the natural language request, wherein the response includes context supporting the response to the inquiry.

15. A non-transitory computer-readable storage medium, having embodied thereon a program executable by a processor to perform a method for data pattern analysis, the method comprising:
receiving, by a computing system, an input including an upload of a document, the uploaded document comprising content for analysis by an LLM;
extracting, by the computing system, the content from the uploaded document, wherein the extraction is configured to preserve an integrity of the content into one or more sets of extracted text;
translating the one or more sets of extracted text into high-dimensional embeddings using an open-source embedding model, wherein the high-dimensional embeddings and the extracted text are stored in a vector database;
receiving, by the computing system, an input comprising a selection of a template from one or more predefined templates, each template comprising a set of analysis characteristics to utilize in the analysis of the content of the uploaded document, and one or more inquiries for the LLM to conduct the analysis using context from the content;
in response to the selection, querying the vector database based on the set of analysis characteristics in the selected template to retrieve language from the document, wherein the query identifies semantically similar language to the set of analysis characteristics;
inputting the retrieved language including a context of the retrieved language and one or more instructions for performing the analysis into the LLM, wherein the LLM is configured to generate one or more insights related to the content related to the set of analysis characteristics, the one or more insights including a vulnerability score and one or more recommendations to remediate the vulnerability score; and
generating, at the computing system, a report including the one or more generated insights received from the LLM, wherein the report includes the vulnerability score of the content and the one or more recommendations.

16. The non-transitory computer-readable storage medium of claim 15, wherein the uploaded document is stored a scalable Amazon Simple Storage Service (AWS S3).

17. The non-transitory computer-readable storage medium of claim 15, wherein the extracting includes the extraction of a plurality of text layouts, paragraphs, lists, continuous statements, and tables from the uploaded document.

18. The non-transitory computer-readable storage medium of claim 15, wherein the vector database stores the high-dimensional embeddings and the extracted text in one or more collections allowing for processing of a semantic search and retrieval of relevant information upon receiving a request.

19. The non-transitory computer-readable storage medium of claim 15, wherein the set of analysis characteristics includes a plurality of categories including one or more definitions, terms, and exclusion types for use in the analysis of the content of the uploaded document for comparison with a predefined data set of organizational best practices.

20. The non-transitory computer-readable storage medium of claim 15, further comprising:
receiving, by the computing system, an input via a chatbot associated with the computing system, the input comprising a natural language request including one or more inquiries for further analysis of the content of the uploaded document to identify compliance with the set of analysis characteristics;
inputting the natural language request into the LLM for processing; and
outputting, by the computing system, a response generated by the LLM in response to the natural language request, wherein the response includes context supporting the response to the inquiry.
